(19) United States
(12) Patent Application Publication
(10) Pub. No.: US 2013/0019407 A1
(43) Pub. Date: Jan. 24, 2013

(54) TILT MOTION LEISURE ADJUSTABLE BED

(71) Applicant: BRUCE ALAN SHEPPARD, Cathedral City, CA (US)

(72) Inventor: BRUCE ALAN SHEPPARD, Cathedral City, CA (US)

(21) Appl. No.: 13/550,323

(22) Filed: Jul. 16, 2012

Related U.S. Application Data
(60) Provisional application No. 61/572,559, filed on Jul. 18, 2011.

(51) Int. Cl. A61G 7/015; A61G 7/012; A61G 7/018

(52) U.S. Cl. 5/611

(57) ABSTRACT

An adjustable bed adaptable to tilt in a number of different, comfortable positions is presented. The adjustable bed comprises a bed frame, a mattress support plate, a plurality of pairs of supporting legs, a plurality of lateral leg supporting members, a plurality of elongated structures, a mattress retainer bar, a sliding member, a central cross bar, a control box, a power supply module, a remote control, a battery compartment, a back rest motor, a foot rest motor, a plurality of levers and a bed lift mechanism. The bed lift mechanism includes at least one motor claw, a left lifting leg, a right lifting leg, a left mounting bracket, a right mounting bracket and a bed lift motor. The back rest motor, the foot rest motor and the bed lift motor receives an operating signal transmitted by the remote controller and tilts the adjustable bed in the plurality of comfortable positions.

This application claims the benefit of U.S. Provisional Application No. 61/572,559 filed on Jul. 18, 2011.

### BACKGROUND OF THE INVENTION

1. Technical Field of the Invention

The present embodiment relates in general to adjustable beds. More specifically, the present embodiment provides an adjustable tilting bed adaptable to tilt in a number of different, comfortable positions automatically and possesses an aesthetic and stylish appearance.

2. Description of the Related Art

A wide variety of adjustable beds have been developed in the art. The adjustable beds are adaptable to change into a number of comfortable positions. The adjustable beds are commonly used in hospitals, rehabilitation centers and for in-home use. It is very difficult for the patients who have undergone major surgeries like knee surgery and orthopedic surgeries to get out of bed comfortably. The adjustable beds help these patients to relocate to and from their beds more easily. Also, these adjustable beds assist the patient to lie in different comfortable positions. The adjustable beds are very helpful for patients suffering from sleep disorders like sleep apnea. It is advisable for these patients to keep their head in a raised position while sleeping. The adjustable beds allow them to keep their heads comfortably in a raised position higher than their foot.

Adjustable beds are also now viewed as part of a home's decor. These adjustable beds are more aesthetic and stylish in appearance than the traditional adjustable beds used in hospitals or medical facilities. These stylish adjustable beds also provide the same great comfort and relaxation as the traditional adjustable beds. A user can watch television, read books, browse internet and perform similar leisure time activities while lying on these beds. It is very easy to change the settings for the adjustable beds to convert from one comfortable position to another. This enables a person to change from a sitting position to a lying position with little or no effort.

Existing, conventional adjustable beds have considerable drawbacks. For example, in an existing device, a tilt bed comprises a frame, a tilting mechanism, a mattress support plate, a mattress, and a foot support. The tilting mechanism is movable between a horizontal position and a vertical position. The foot support is fixedly mounted to the tilting mechanism. Even so, this tilt bed assembly allows only two tilting positions for a patient and there is no provision to adjust the head rest portion and the foot rest portion of the tilt bed. So this tilt bed is not suitable for patients suffering from sleep apnea.

Another example describes a bed having a deck assembly that is supported by a base assembly. The base assembly includes a tilting actuator assembly. The base assembly is coupled to the deck assembly so that the deck assembly can be tilted from a prone position to an upright position. The base assembly and the deck assembly are coupled so that there are no easily accessible pinch points therebetween. However, this device has a bulky structure and requires frequent maintenance. Further, this tilting bed is designed to tilt only in a limited number of positions. Also, this tilt bed cannot normally be used as part of the home decor since it lacks an aesthetic appearance.

Many attempts are made in the existing adjustable beds to make them capable of adjustment to a multiple number of positions. One of such solutions is a tilt bed assembly having a bed frame, a tilt bed installed in the bed frame, and at least a first linear motor for tilting the tilt bed along a desired direction to a desired degree of adjustment. The bed frame has a horizontal base panel, a first vertical panel and a second vertical panel. The first and second vertical panels support the base panel and each of the first and second vertical boards is perforated with a hole. The tilt bed adjusts the position of a patient lying thereon to a desired position without disturbing the patient. Further, this tilt bed is adaptable to incorporate an automatic control system that can activate the linear motors automatically. Even so, in this automatic tilting system, a care giver is required to input the data regarding the desired position in a computer every time the patient wants to change the bed position. Therefore, this system cannot be operated in a quick manner and needs an additional care giver for entering the required data into the computer.

Hence, it can be seen, that there is a need for a device that would be simple in construction and highly reliable. Such a device would allow the patient to change the bed position automatically without the need of an additional care giver. Further, such a needed device would be adaptable to being tilted in a multiple number of positions like back rest tilting, foot rest tilting, bed lifting etc. Such a needed device would be designed to tilt in a desired angle and height. Moreover, such a needed device would have an aesthetic appearance and would be utilized as a home decor.

### SUMMARY OF THE INVENTION

To minimize the limitations found in the prior art, and to minimize other limitations that will be apparent upon the reading of the specifications, the present invention is an adjustable bed adaptable to tilt in a number of different, comfortable positions. In the preferred embodiment, the adjustable bed comprises a bed frame, a mattress support plate, a plurality of pairs of supporting legs, a plurality of lateral leg supporting members, a plurality of elongated structures, a mattress retainer bar, a sliding member, a central cross bar, a control box, a power supply module, a remote control, a battery compartment, a back rest motor, a foot rest motor, a plurality of levers and a bed lift mechanism.

The bed frame includes a left side, a right side, a head end, a foot end and a plurality of bed corners. The mattress support plate is positioned over the bed frame for securely holding a mattress. The mattress support plate includes a back rest, a foot rest and a plurality of middle portions. The plurality of comfortable positions includes lifting up the back rest, lifting down the back rest, lifting up the foot rest, lifting down the foot rest and a plurality of bed lifting positions. The bed lift mechanism includes at least one motor claw, a left lifting leg, a right lifting leg, a left mounting bracket, a right mounting bracket and at least one bed lift motor.

The remote control is designed to transmit at least one operating signal for regulating the working of the adjustable bed. The remote control includes a plurality of control buttons. Each of the plurality of control buttons is adaptable to tilt the adjustable bed in the plurality of comfortable positions. The battery compartment includes at least one battery to provide power to the remote control.

Each of the plurality of lateral leg supporting members is connected with each of the pairs of supporting legs and is located below the back rest and the foot rest. The sliding member is connected to the plurality of elongated structures. The plurality of elongated structures is connected to each of the plurality of lateral leg supporting members. The central cross bar is connected to the sliding member. The central cross bar allows the transportation of the bed frame easier. At least one of the plurality of cable connections is connected with the power supply module. The power supply module provides electric power to the adjustable bed. The plurality of levers is positioned below the back rest. Each of the plurality of levers is connected to the mattress support plate and each of the plurality of elongated structures. The plurality of levers allows the adjustable bed to move in various angular positions. The back rest motor is connected to the back rest of the mattress support plate. The back rest motor is designed to receive the at least one operating signal transmitted by the remote control and moves the plurality of levers to tilt the back rest in the plurality of comfortable positions.

The sliding member is designed to move forward and backward along with the movement of the plurality of levers for tilting the adjustable bed in the desired heights. The foot rest motor is connected with the foot rest. The foot rest motor is designed to receive the at least one operating signal transmitted by the remote control and moves the plurality of levers to tilt the foot rest in the plurality of comfortable positions. The back rest motor and the foot rest motor are in electrical communication with the power supply module. The mattress retainer bar is positioned at the foot end to retain the mattress over the bed frame when the adjustable bed moves in the plurality of comfortable positions. The bed lift mechanism is adaptable to move the adjustable bed to attain a desired level.

One objective of the invention is to provide an adjustable bed adaptable to tilt in a number of different, comfortable positions.

A second objective of the invention is to provide an adjustable bed adaptable to being tilted in a multiple number of positions like back rest tilting, foot rest tilting and bed lifting positions.

A third objective of the invention is to provide a bed lift mechanism adaptable to move the adjustable bed in a desired height level.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention, illustrating an adjustable bed attached with a mattress;

FIG. 2 is a perspective view of the present invention, illustrating the adjustable bed in a tilted position;

FIG. 3 is a perspective view of the present invention, illustrating a bed frame of the adjustable bed;

FIG. 4 is a perspective view of the present invention, illustrating a remote control;

FIG. 5 is a perspective view of the present invention, illustrating a sliding member, a plurality of elongated structures and a plurality of levers of the adjustable bed;

FIG. 6 is a perspective view of the present invention, illustrating a back rest of the adjustable bed in a raised position;

FIG. 7 is a perspective view of the present invention, illustrating the adjustable bed frame in a raised position;

FIG. 8 is a perspective view of the present invention, illustrating a left lifting leg and a right lifting leg of the adjustable bed;

FIG. 9 is a perspective view of a bed lift mechanism of the adjustable bed of the present invention; and

FIG. 10 is a perspective view of a left mounting bracket of the adjustable bed of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

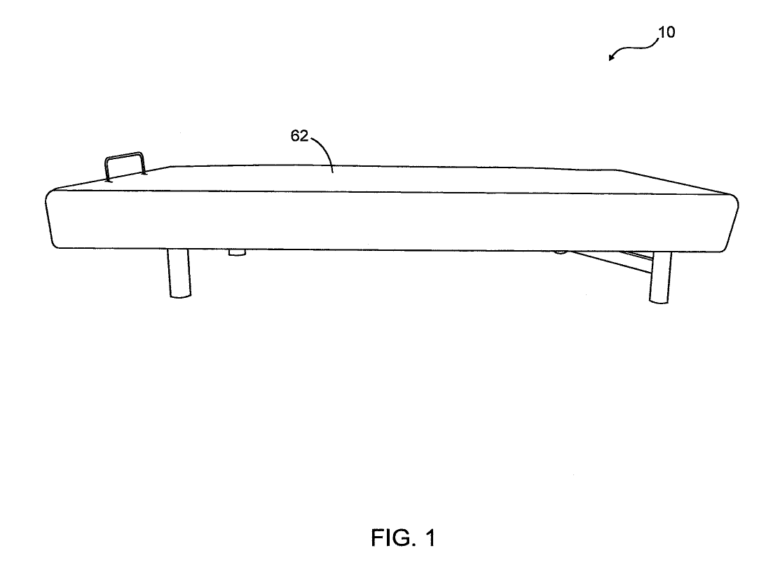

FIG. 1 illustrates an adjustable bed 10 attached with a mattress 62. The adjustable bed 10 is adaptable to tilt in a number of different, comfortable positions.

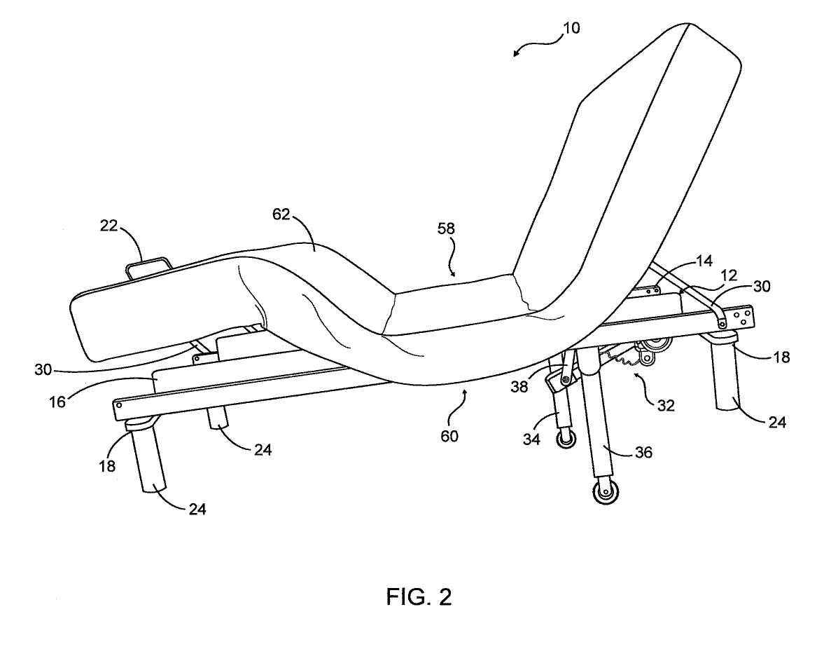

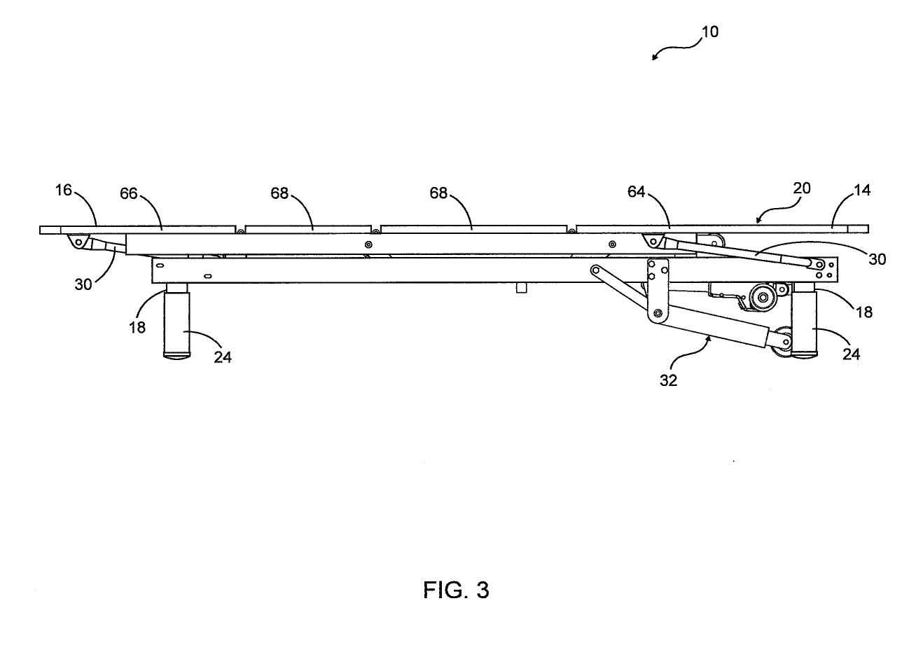

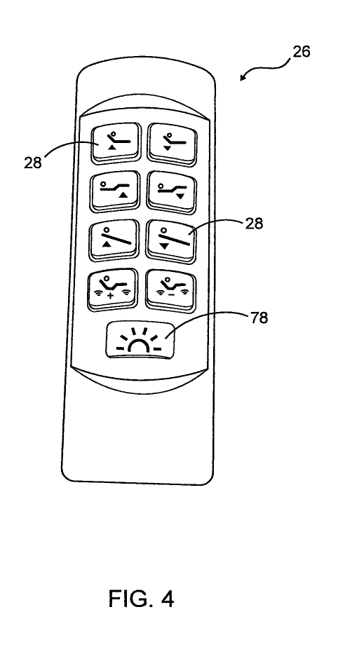

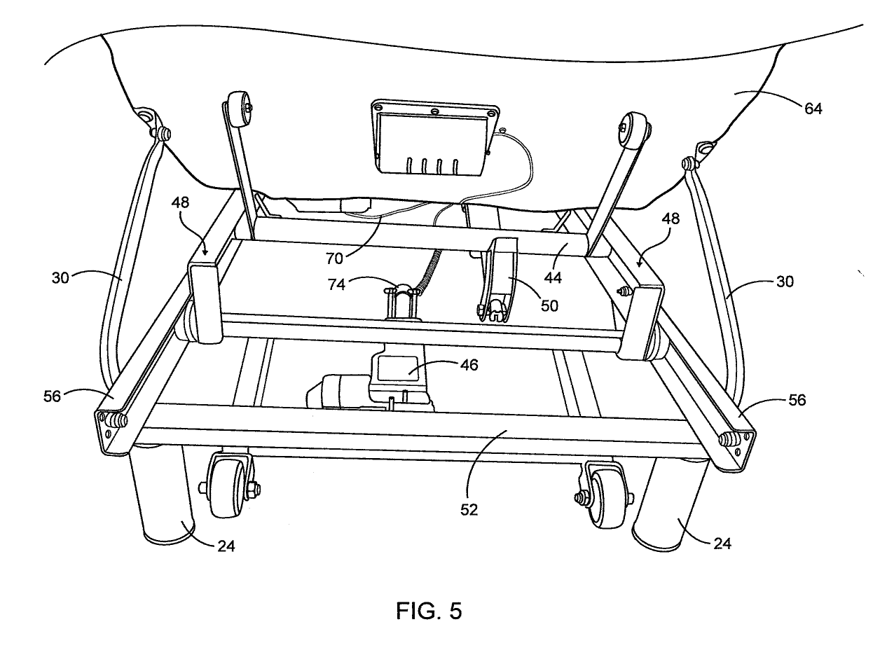

Referring to FIGS. 2-3, the adjustable bed 10 comprises a bed frame 12, a mattress support plate 20, a plurality of pairs of supporting legs 24, a plurality of lateral leg supporting members 52 (FIG. 5), a plurality of elongated structures 56 (FIG. 5), a mattress retainer bar 22, a sliding member 48 (FIG. 5), a central cross bar 44 (FIG. 5), a control box (not shown), a power supply module (not shown), a remote control 26 (FIG. 4), a battery compartment (not shown), a back rest motor (not shown), a foot rest motor (not shown), a plurality of levers 30 and a bed lift mechanism 32.

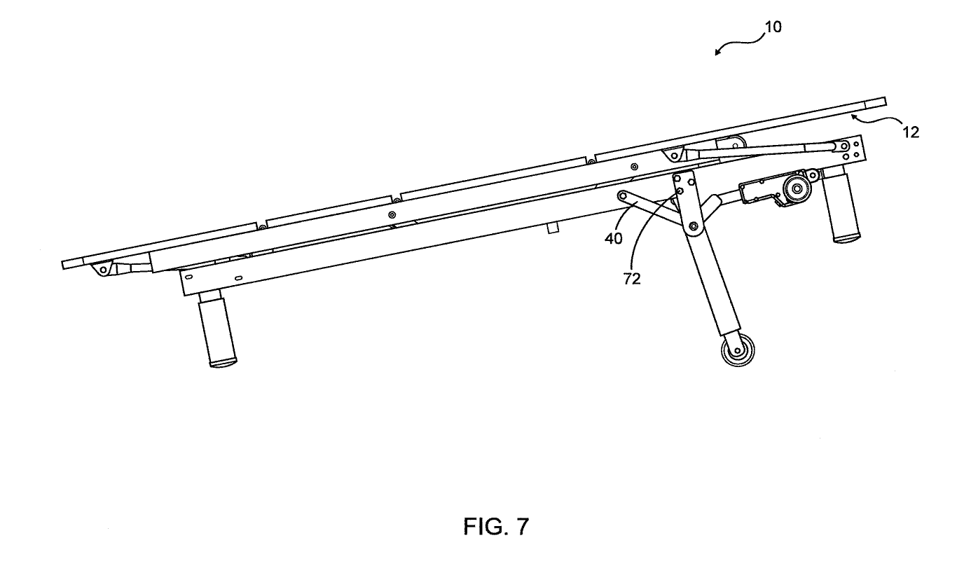

The bed frame 12 includes a left side 58 with a plurality of left apertures (not shown), a right side 60 with a plurality of right apertures (not shown), a head end 14, a foot end 16 and a plurality of bed corners 18. The mattress support plate 20 is positioned over the bed frame 12 for securely holding the mattress 62. The mattress support plate 20 includes a back rest 64, a foot rest 66 and a plurality of middle portions 68. Each of the plurality of pairs of supporting legs 24 is connected to each of the plurality of bed corners 18. The plurality of comfortable positions includes lifting up the back rest 64, lifting down the back rest 64, lifting up the foot rest 66, lifting down the foot rest 66 and a plurality of other bed lifting positions of interest. The bed frame 12 further includes a plurality of threaded holes (not shown). Each of the plurality of threaded holes (not shown) is positioned at the plurality of bed corners 18 of the bed frame 12. Each of the plurality of supporting legs 24 is connected to each of the plurality of threaded holes (not shown) of the bed frame 12. As shown in FIG. 2, the bed lift mechanism 32 comprises at least one motor claw 50 (FIG. 5), a left lifting leg 34, a right lifting leg 36, a left mounting bracket 38, a right mounting bracket 40 (FIG. 7) and at least one bed lift motor 46 (FIG. 5).

Referring to FIG. 4, a remote control 26 is designed to transmit at least one operating signal for regulating the working of the adjustable bed 10. The remote control 26 includes a plurality of control buttons 28. Each of the plurality of control buttons 28 is adaptable to tilt the adjustable bed 10 in the plurality of comfortable positions. The remote control 26 is operated by pressing and holding at least one of the plurality of control buttons 28 until the adjustable bed 10 tilts to a desired comfortable position. In the preferred embodiment, the control button 78 is adaptable to illuminate the remote control 26. The battery compartment (not shown) is positioned at a rear side of the remote control 26. The battery compartment (not shown) includes at least one battery to provide power to the remote control 26.

As shown in FIG. 5, each of the plurality of lateral leg supporting members 52 is connected with each of the pairs of supporting legs 24 and is located below the back rest 64 and foot rest 66. The sliding member 48 is connected to the plurality of elongated structures 56. The plurality of elongated structures 56 is connected to each of the plurality of lateral leg supporting members 52. The central cross bar 44 is connected to the sliding member 48. The central cross bar 44 allows the transportation of the bed frame 12 easier. The control box (not shown) includes a plurality of electrical sockets (not shown) and a plurality of cable connections 70. At least one of the plurality of cable connections 70 is connected with the power supply module (not shown). The power supply module (not shown) provides electric power to the adjustable bed 10. The power supply module (not shown) includes a power status indicator (not shown) to indicate the status of power therein.

The plurality of levers 30 is positioned below the back rest 64. Each of the plurality of levers 30 is connected to the mattress support plate 20 and each of the plurality of elongated structures 56. The plurality of levers 30 allows the adjustable bed 10 to move in various angular positions. The plurality of levers 30 includes a plurality of lever holes (not shown). The back rest motor (not shown) is connected to the back rest 64 of the mattress support plate 20. The back rest motor (not shown) is designed to receive the at least one operating signal transmitted by the remote control 26 and moves the plurality of levers 30 to tilt the back rest 64 in the plurality of comfortable positions. The sliding member 48 is designed to move forward and backward along with the movement of the plurality of levers 30 for tilting the adjustable bed 10 in the desired heights. The foot rest motor (not shown) is connected with the foot rest 66. The foot rest motor (not shown) is designed to receive the at least one operating signal transmitted by the remote control 26 and moves the plurality of levers 30 to tilt the foot rest 66 in the plurality of comfortable positions. The back rest motor (not shown) and the foot rest motor (not shown) are in electrical communication with the power supply module (not shown).

The at least one bed lift motor 46 is electrically connected to the control box (not shown) and power supply module (not shown). The at least one bed lift motor 46 includes a first end section (not shown) having a plurality of first end motor holes (not shown) and a second end section 74 having a plurality of second end motor holes (not shown). The first end section (not shown) is connected between the plurality of levers 30 by fastening the plurality of first end motor holes (not shown) with the plurality of lever holes (not shown) utilizing a plurality of fastening means (not shown). The second end section 74 is connected to the at least one motor claw 50 by fastening the plurality of second end motor holes (not shown) with the plurality of motor claw holes (not shown) utilizing the plurality of fastening means (not shown). The at least one bed lift motor 46 is installed between the plurality of levers 30 at an optimal orientation of 180 degree.

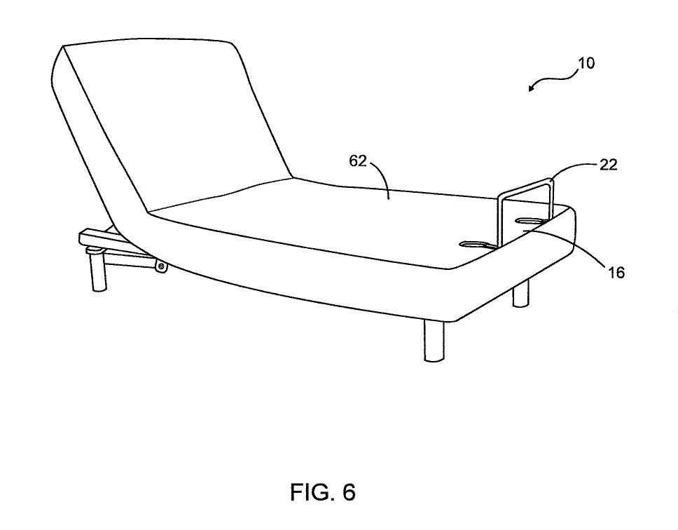

As shown in FIG. 6, the mattress retainer bar 22 is positioned at the foot end 16 to retain the mattress 62 over the bed frame 12 when the adjustable bed 10 moves in the plurality of comfortable positions. In the preferred embodiment, the mattress retainer bar 22 is electroplated with Chromium. Referring to FIG. 7, the right mounting bracket 40 is attached with the bed frame 12 by connecting the plurality of second apertures (not shown) to the plurality of right apertures (not shown) of the bed frame 12 utilizing a plurality of connecting means 72. The left mounting bracket 38 is attached with the bed frame 12 by connecting the plurality of first apertures (not shown) to the plurality of left apertures (not shown) of the bed frame 12 utilizing the plurality of connecting means 72.

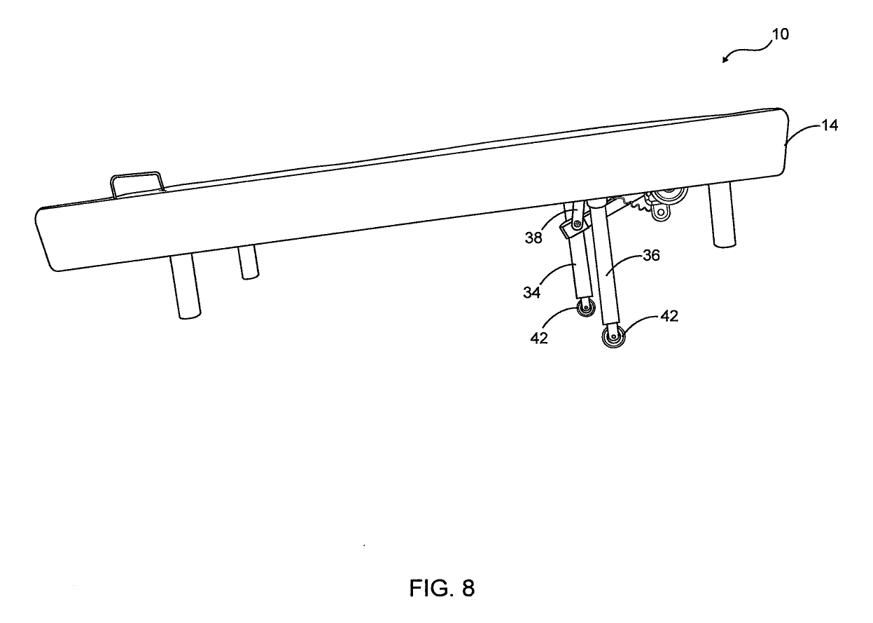

As shown in FIG. 8, the left lifting leg 34 and the right lifting leg 36 are positioned below the head end 14 of the bed frame 12. The left lifting leg 34 and the right lifting leg 36 includes at least one roller 42 attached thereon. The right lifting leg 36 and the left lifting leg 34 are designed to roll simultaneously utilizing the at least one roller 42. The at least one roller 42 allows to lift the adjustable bed 10 easily and comfortably. At least one of the plurality of first apertures (not shown) of the left mounting bracket 38 is large sized and is equipped with a bushing component (not shown) that helps to firmly connect the left mounting bracket 38 with the bed frame 12. Similarly, at least one of the plurality of second apertures (not shown) of the right mounting bracket 40 is large sized. The at least one of the plurality of second apertures (not shown) is equipped with the bushing component (not shown) that helps to firmly connect the right mounting bracket 40 with the bed frame 12.

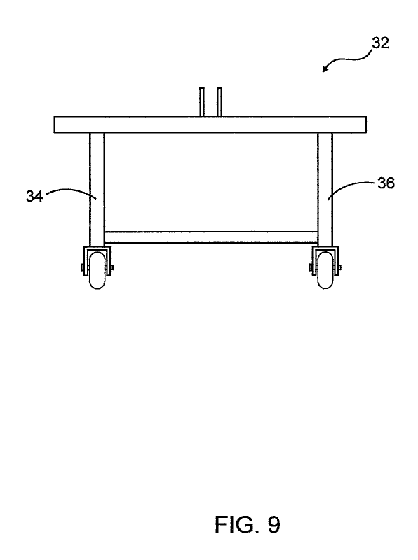

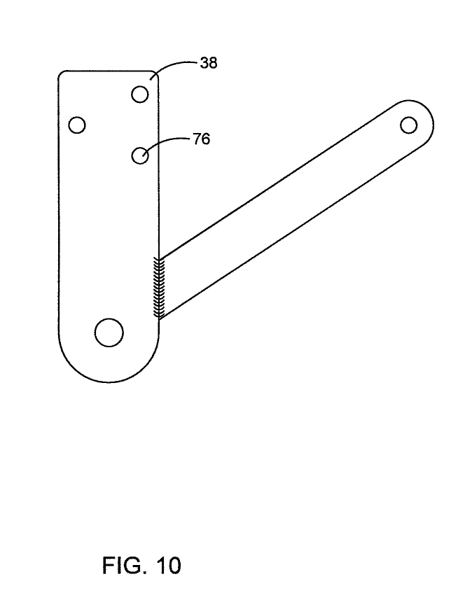

Referring to FIG. 9, the bed lift mechanism 32 is attached with the bed frame 12. The bed lift mechanism 32 is adaptable to move the adjustable bed 10 to attain a desired level. The desired level includes a plurality of raised positions and a plurality of lower positions of the bed frame 12. The at least one motor claw 50 includes a plurality of motor claw holes (not shown). The left lifting leg 34 is positioned at the left side 58 of the bed frame 12. The right lifting leg 36 is positioned at the right side 60 of the bed frame 12. The at least one bed lift motor 46 receives the at least one operating signal and rolls the right lifting leg 36 and the left lifting leg 34 to move the adjustable bed 10 in the raised positions and in the lower positions. As shown in FIG. 10, the left mounting bracket 38 is connected with the left lifting leg 34. The left mounting bracket 38 includes a plurality of first apertures 76. The right mounting bracket 40 includes a plurality of second apertures (not shown) to connect with the bed frame 12 utilizing the plurality of connecting means 72. The adjustable bed 10 can be customized to hold different sized mattresses like king size, queen size and twin size. Depending on the size of the adjustable bed 10 and the user's requirements, the adjustable bed 10 can hold any number of mattresses. If the adjustable bed 10 is queen sized and separate operation for two users is desired, then two mattresses 62 with individual tilting assemblies can be used.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An adjustable bed, comprising:
a bed frame having a left side, a right side, a head end, a foot end and a plurality of bed corners, the left side includes a plurality of left apertures, the right side includes a plurality of right apertures;
a mattress support plate positioned over the bed frame for securely holding a mattress at the bed frame, the mattress support plate includes a back rest, a foot rest and a plurality of middle portions;
a plurality of pairs of supporting legs, each of the plurality of pairs of supporting legs is connected to each of the plurality of bed corners;
a plurality of lateral leg supporting members, each of the plurality of lateral leg supporting members being connected to each of the pairs of supporting legs;
a plurality of elongated structures connected to the plurality of lateral leg supporting members;
a sliding member connected to the plurality of elongated structures;
a central cross bar connected to the sliding member;
a mattress retainer bar positioned at the foot end to retain the mattress over the bed frame when the adjustable bed moves in a plurality of comfortable positions;
a power supply module for providing electric power to the adjustable bed, the power supply module includes a power status indicator to indicate the status of power in the power supply module;
a control box having a plurality of electrical sockets and a plurality of cable connections, at least one of the plurality of cable connections being connected to the power supply module;
a remote control designed to transmit at least one operating signal adaptable to tilt the adjustable bed in the plurality of comfortable positions, the remote control includes a plurality of control buttons, each of the plurality of control buttons being adaptable to tilt the adjustable bed in the plurality of comfortable positions;
a battery compartment positioned at a rear side of the remote control, the battery compartment includes at least one battery to provide power to the remote control;
a plurality of levers for allowing the adjustable bed to move in various angular positions, each of the plurality of levers being connected to the mattress support plate and to each of the plurality of elongated structures, the plurality of levers includes a plurality of lever holes;
a back rest motor connected to the back rest, the back rest motor receives the at least one operating signal transmitted by the remote control and moves the plurality of levers to tilt the back rest in the plurality of comfortable positions, the back rest motor being in electrical communication with the power supply module;
a foot rest motor connected to the foot rest, the foot rest motor receives the at least one operating signal transmitted by the remote control and moves the plurality of levers to tilt the foot rest in the plurality of comfortable positions, the foot rest motor being in electrical communication with the power supply module; and
a bed lift mechanism attached with the sliding member, the bed lift mechanism being adaptable to move the adjustable bed in a raised position and in a lower position, the bed lift mechanism, comprising:
at least one motor claw having a plurality of motor claw holes;
a left lifting leg having at least one roller attached thereon;
a right lifting leg having the at least one roller attached thereon, the right lifting leg and the left lifting leg roll simultaneously utilizing the at least one roller to move the adjustable bed in the raised position and in the lower position;
a left mounting bracket connected to the left lifting leg, the left mounting bracket includes a plurality of first apertures, the left mounting bracket being connected with the left lifting leg;
a right mounting bracket connected with the right lifting leg, the right mounting bracket includes a plurality of second apertures, the right mounting bracket being connected with the right lifting leg; and
at least one bed lift motor electrically connected to the control box and the power supply module, the at least one bed lift motor receives the at least one operating signal and rolls the right lifting leg and the left lifting leg to move the adjustable bed to attain a desired level, the at least one bed lift motor includes a first end section having a plurality of first end motor holes and a second end section having a plurality of second end motor holes, the first end section being connected between the plurality of levers and the second end section being connected to the at least one motor claw;
whereby the back rest motor, the foot rest motor and the at least one bed lift motor receives the at least one operating signal and tilts the adjustable bed in the plurality of comfortable positions.

2. The adjustable bed of claim 1 wherein the remote control operatively tilts the adjustable bed in the plurality of comfortable positions by pressing and holding at least one of the plurality of control buttons until the adjustable bed tilts to a desired comfortable position.

3. The adjustable bed of claim 1 wherein the left lifting leg and the right lifting leg are positioned below the head end of the bed frame.

4. The adjustable bed of claim 1 wherein the at least one roller allows to lift the adjustable bed easily and comfortably.

5. The adjustable bed of claim 1 wherein at least one of the plurality of first apertures of the left mounting bracket is large sized.

6. The adjustable bed of claim 5 wherein the at least one of the plurality of first apertures is equipped with a bushing component for firmly connecting the left mounting bracket to the bed frame.

7. The adjustable bed of claim 1 wherein at least one of the plurality of second apertures of the right mounting bracket is large sized.

8. The adjustable bed of claim 7 wherein the at least one of the plurality of second apertures is equipped with the bushing component for firmly connecting the right mounting bracket to the bed frame.

9. The adjustable bed of claim 1 wherein the plurality of levers is positioned below the back rest.

10. The adjustable bed of claim 1 wherein the at least one bed lift motor is connected between the plurality of levers by fastening the plurality of first end motor holes with the plurality of lever holes utilizing a plurality of fastening means.

11. The adjustable bed of claim 1 wherein the at least one bed lift motor is connected with the at least one motor claw by fastening the plurality of second end motor holes with the plurality of motor claw holes utilizing the plurality of fastening means.

12. The adjustable bed of claim 1 wherein the at least one bed lift motor is installed between the plurality of levers at an optimal orientation.

13. The adjustable bed of claim 1 wherein the bed frame further comprises a plurality of threaded holes positioned at the plurality of corners of the bed frame.

14. The adjustable bed of claim 13 wherein each of the plurality of supporting legs is connected to each of the plurality of threaded holes in the bed frame.

15. The adjustable bed of claim 1 wherein the plurality of comfortable positions includes lifting up the back rest, lifting down the back rest, lifting up the foot rest, lifting down the foot rest and a plurality of bed lifting positions.

16. The adjustable bed of claim 1 wherein at least one of the plurality of control buttons is adaptable to illuminate the remote control.

17. The adjustable bed of claim 1 wherein the left mounting bracket is attached with the bed frame by connecting the plurality of first apertures to the plurality of left apertures of the bed frame utilizing a plurality of connecting means.

18. The adjustable bed of claim 1 wherein the right mounting bracket is attached with the bed frame by connecting the plurality of second apertures to the plurality of right apertures of the bed frame utilizing the plurality of connecting means.

19. The adjustable bed of claim 1 wherein the central cross bar allows the transportation of the bed frame easier.
